(19) United States
(12) Patent Application Publication
(10) Pub. No.: US 2010/0207433 A1
(43) Pub. Date: Aug. 19, 2010

(54) SEAT WITH ENERGY ABSORPTION DEVICE

(75) Inventor: Douglas C. Hahn, La Valle, WI (US)

Correspondence Address: MICHAEL BEST & FRIEDRICH LLP, 100 E WISCONSIN AVENUE, Suite 3300, MILWAUKEE, WI, 53202, US

(73) Assignee: SEATS, INC., Reedsburg, WI (US)

(21) Appl. No.: 12/372,396

(22) Filed: Feb. 17, 2009

(51) Int. Cl. B60N 2/42

(52) U.S. Cl. 297/216.1

(57) ABSTRACT

A seat for a vehicle. The seat includes an occupant support defining a support surface for an occupant of the seat, and a mounting assembly coupled to the occupant support and rigidly mounted to the vehicle. The mounting assembly resists non-vertical movement and guides vertical movement of the occupant support relative to the mounting assembly. The seat also includes a shear member having a first hardness and a sacrificial member have a second hardness lower than the first hardness. The sacrificial member is sheared by the shear member in response to a generally downward force on the occupant support arising from inertia of the occupant in the presence of a rapid upward movement of the vehicle. Shearing the sacrificial member absorbs energy associated with the rapid upward movement of the vehicle and accommodates downward movement of the occupant support relative to the mounting assembly, reducing acceleration of the occupant.

### BACKGROUND

The present invention relates an energy absorption device for a seat of a vehicle, and more particularly, the present invention relates to an energy absorption device that protects a seat occupant from rapid upward accelerations of the vehicle.

Some vehicles (e.g., a military vehicle) may be subjected to rapid upward movement caused by an explosion under the vehicle. Often, when an explosion occurs under the vehicle, the force of the explosion is transferred to the upper vehicle structure. In particular, the explosive force rapidly accelerates the seat upward, which in turn causes an occupant of the seat to move rapidly upward. Rapid upward movement of the occupant can undesirably jar or jolt the occupant, and may cause serious injury to the occupant.

### SUMMARY

In one construction, the present invention provides a seat for a vehicle. The seat includes an occupant support that defines a support surface for an occupant of the seat, and a mounting assembly that is coupled to the occupant support and that is adapted to rigidly mount to the vehicle. The mounting assembly is further adapted to resist non-vertical movement of the occupant support relative to the mounting assembly, and to guide vertical movement of the occupant support relative to the mounting assembly. The seat also includes a shear member that has a first hardness, and a sacrificial member that has a second hardness lower than the first hardness. One of the shear member and the sacrificial member is adapted to be rigidly mounted to the vehicle and the other of the shear member and the sacrificial member is rigidly mounted to the occupant support. The shear member is engaged with the sacrificial member to inhibit vertical movement of the occupant support relative to the mounting assembly under expected ordinary operating conditions of the vehicle. A circumferential portion of the sacrificial member is sheared by the shear member in response to a generally downward force on the occupant support arising from inertia of the occupant in the presence of a rapid upward movement of the vehicle. The shearing of the sacrificial member by the shear member absorbs energy associated with the rapid upward movement of the vehicle and accommodates downward movement of the occupant support relative to the mounting assembly. The absorption of energy by shearing the sacrificial member reduces acceleration of the occupant.

Other aspects of the invention will become apparent by consideration of the detailed description and accompanying drawings.

### BRIEF DESCRIPTION OF THE DRAWINGS

FIG. 1 is a perspective view of a seat assembly embodying the present invention.

FIG. 2 is a rear perspective view of the seat assembly of FIG. 1 including a mounting assembly, an occupant support, and an energy absorption device in a first state.

FIG. 3 is a rear perspective view of a portion of the seat assembly of FIG. 2 including the energy absorption device.

FIG. 4 is a section view of the seat assembly of FIG. 3 taken along line 4-4, showing the energy absorption device in the first state.

FIG. 5 is a perspective view of a portion of the energy absorption device including a sacrificial member and a shear member in the first state.

FIG. 6 is an end view of the sacrificial member of FIG. 5.

FIG. 7 is an end view of the shear member of FIG. 5.

FIG. 8 is a rear perspective view of the seat assembly including the energy absorption device in a second state.

FIG. 9 is a perspective view of the sacrificial member and the shear member in the second state.

FIG. 10 is a section view of a portion of the seat assembly of FIG. 8 taken along line 10-10, showing the energy absorption device in the second state.

FIG. 11 is a perspective view of a portion of another energy absorption device for the seat assembly of FIG. 1.

FIG. 12 is a perspective view of a portion of another energy absorption device for the seat assembly of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

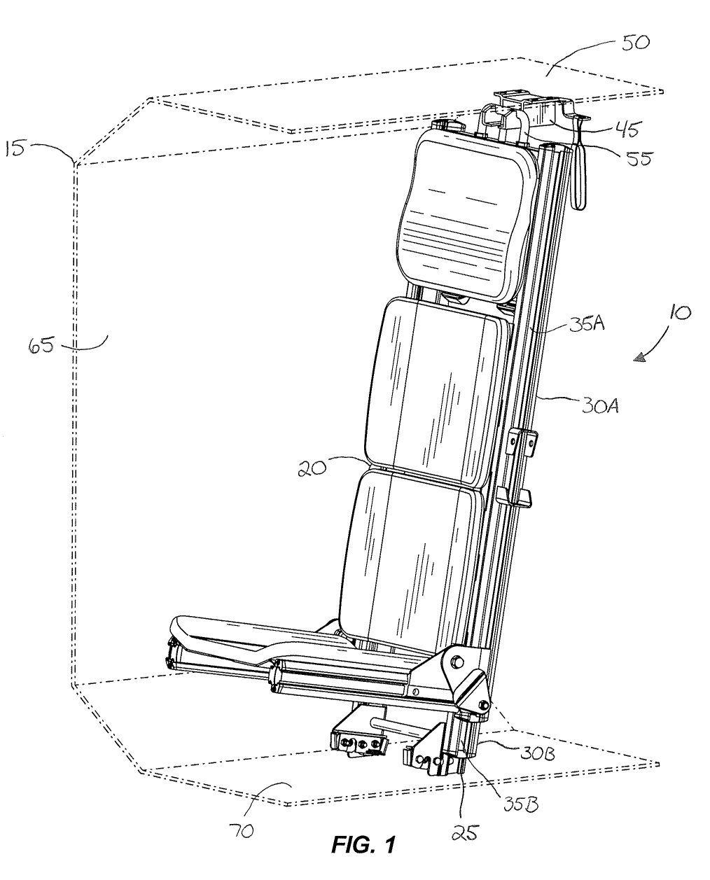

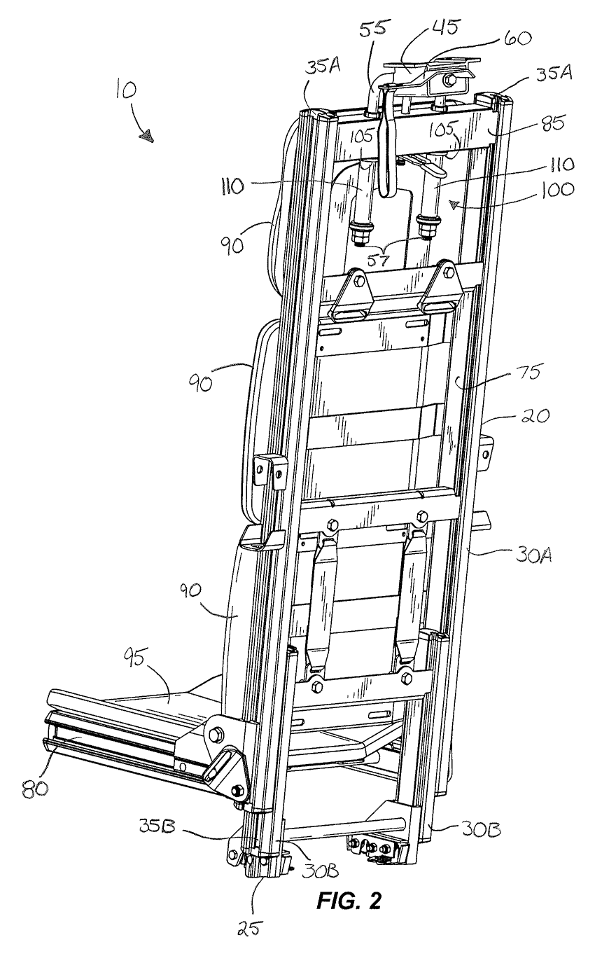

FIGS. 1 and 2 show a seat 10 for a vehicle 15 (e.g., military vehicle 15, etc.). The seat 10 includes an occupant support 20 and a mounting assembly 25 that is coupled to the occupant support 20. The occupant support 20 and the mounting assembly 25 include inter-engaging portions 30A, 30B that facilitate generally vertical movement of the occupant support 20 relative to the mounting assembly 25. The inter-engaging portion 30B of the mounting assembly 25 is interconnected with the inter-engaging portion 30A of the occupant support 20 in a vertical sliding relationship.

In some constructions, the sliding relationship between the inter-engaging portion 30A and the inter-engaging portion 30B may include a telescoping interconnection (e.g., one of the inter-engaging portions 30A, 30B fitting and sliding within the other of the inter-engaging portions 30A, 30B, etc.). In other constructions, the sliding relationship between the inter-engaging portion 30A and the inter-engaging portion 30B may include other sliding interconnections (e.g., the inter-engaging portions 30A, 30B sliding inward or outward in overlapping sections, etc.). As illustrated in FIGS. 1 and 2, the inter-engaging portions 30A, 30B of the occupant support 20 and the mounting support include tracks or extruded channels 35A, 35B that interconnect with each other in a vertical sliding relationship. The extruded channels 35A, 35B cooperatively slide relative to each other to permit relative vertical movement between the occupant support 20 and the mounting assembly 25.

The occupant support 20 is mounted to the vehicle 15 via the mounting assembly 25 and a bracket or wall attachment 45. As illustrated in FIG. 1, the bracket 45 is attached to a ceiling 50 of the vehicle 15 and supports a “U”-shaped attachment arm 55 having threaded ends 57. As shown in FIGS. 1-3, the “U”-shaped attachment arm 55 extends through the occupant support 20 to suspend the occupant support 20 from the ceiling 50 using the bracket 45, and includes threaded ends 57. The bracket 45 includes a lever 60 that is movable upward to selectively release the “U”-shaped attachment arm 55 from the mounting bracket 45.

As used herein, the term “wall” includes the ceiling 50, a sidewall 65 of the vehicle 15, a floor 70 of the vehicle 15, and any other structural part of the vehicle 15 to which the mounting assembly 25 and the bracket 45 may be mounted. In the illustrated construction, the mounting assembly 25 is mounted to the floor 70 and the bracket 45 is mounted to the ceiling 50. In other constructions, the mounting assembly 25 and the bracket 45 may be mounted to any wall.

FIG. 2 shows that the occupant support 20 includes a first frame portion 75 and a second frame portion 80 coupled to the first frame portion 75. In some constructions, the first and second frame portions 75, 80 may be angularly movable relative to each other. The first frame portion 75 defines a generally upright portion of the occupant support 20, and includes a horizontal extrusion 85 positioned adjacent an upper end of the occupant support 20 that interconnects the extruded channels 35A. The first frame portion 75 also includes cushions 90 that may be selectively repositioned on the first frame portion 75. The second frame portion 80 defines a support surface 95 for an occupant of the seat 10.

As shown in FIGS. 1 and 2, the mounting assembly 25 is rigidly mounted to the floor 70 of the vehicle 15 by any suitable fastening means, and the occupant support 20 is movable relative to the mounting assembly 25. In other constructions, the occupant support 20 may be rigidly mounted to the vehicle 15 and the mounting assembly 25 may be movable relative to the occupant support 20. In still other constructions, the mounting assembly 25 may be rigidly mounted to the sidewall 65 of the vehicle 15. The mounting assembly 25 is coupled to the occupant support 20 to resist non-vertical movement of the occupant support 20 (e.g., front-to-back, side-to-side, etc.) relative to the mounting assembly 25, and to guide generally vertical movement of the occupant support 20 relative to the mounting assembly 25.

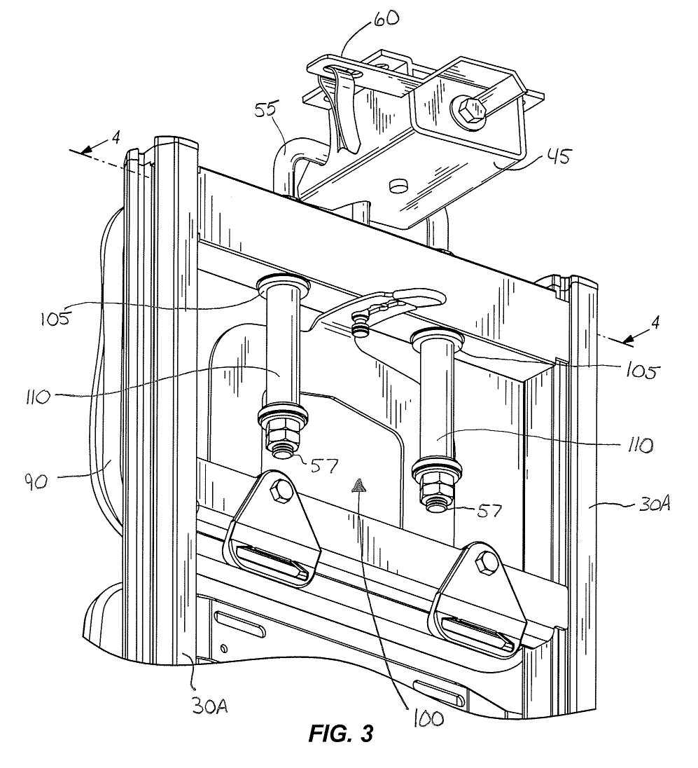

FIGS. 2-4 show that the seat 10 also includes an energy absorption device 100 that is coupled to the horizontal extrusion 85 adjacent an upper portion or top of the occupant support 20. As illustrated in FIGS. 3-7, the energy absorption device 100 includes a shear member 105 having a first hardness, and a sacrificial member 110 having a second hardness that is lower than the first hardness. In the illustrated construction, the shear member 105 is formed from a metal or alloy (e.g., steel, aluminum, etc.), and the sacrificial member 110 is formed from a plastic (e.g., Teflon). Other materials (e.g., composite, etc.) for the shear member 105 and the sacrificial member 110 are possible and considered herein.

The length of the sacrificial member 110 is at least partially determined based on the vertical space available in the vehicle 15. A relatively long sacrificial member 110 provides a greater length over which energy may be dissipated or absorbed by the energy absorption device 100. The overlap of the inter-engaging portions 30A, 30B of the occupant support 20 and the mounting assembly 25 correlates to the length of the sacrificial member 110 and is generally determined by desired energy absorption characteristics or force dissipation properties of the energy absorption device 100 in response to rapid upward movement of the vehicle 15. The desired energy absorption characteristics also may be determined or established by one or more properties (e.g., shape, length, cross-sectional diameter or width, material, etc.) of the shear member 105 and the sacrificial member 110. Generally, rapid upward movement of the vehicle 15 is defined as abnormal or aberrant movement of the vehicle 15, and includes or is consistent with an explosion occurring under the vehicle 15.

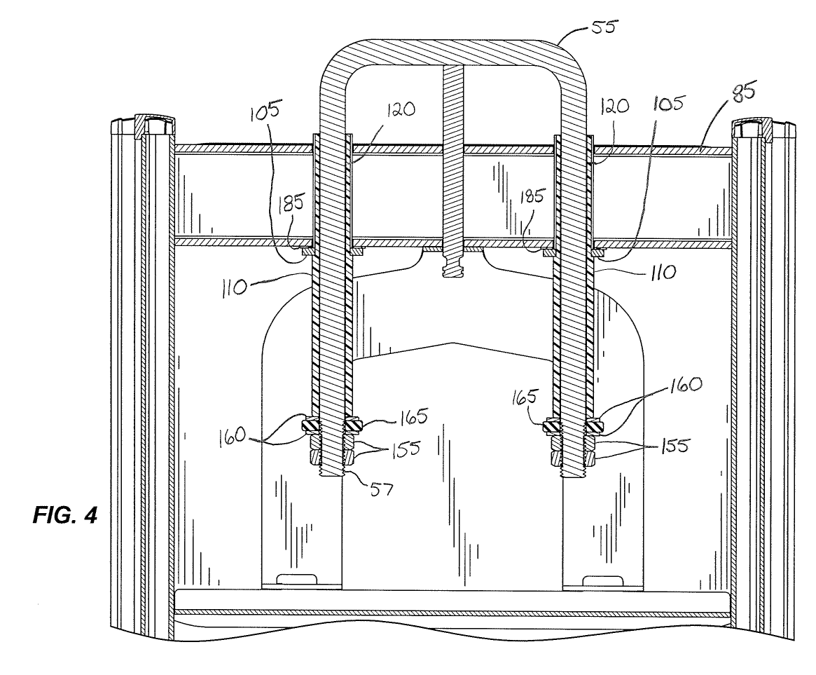

As shown in FIGS. 4-6, the sacrificial member 110 includes a bar 115 that has a first portion 120, a second portion 125 that abuts the first portion 120, and a cavity 130 extending the entire length of the bar 115 along an axis 135. Given a fixed length bar 115, the respective lengths of the first portion 120 and the second portion 125 are at least partially determined by the desired energy absorption characteristics and the material properties of the shear member 105 and/or the sacrificial member 110.

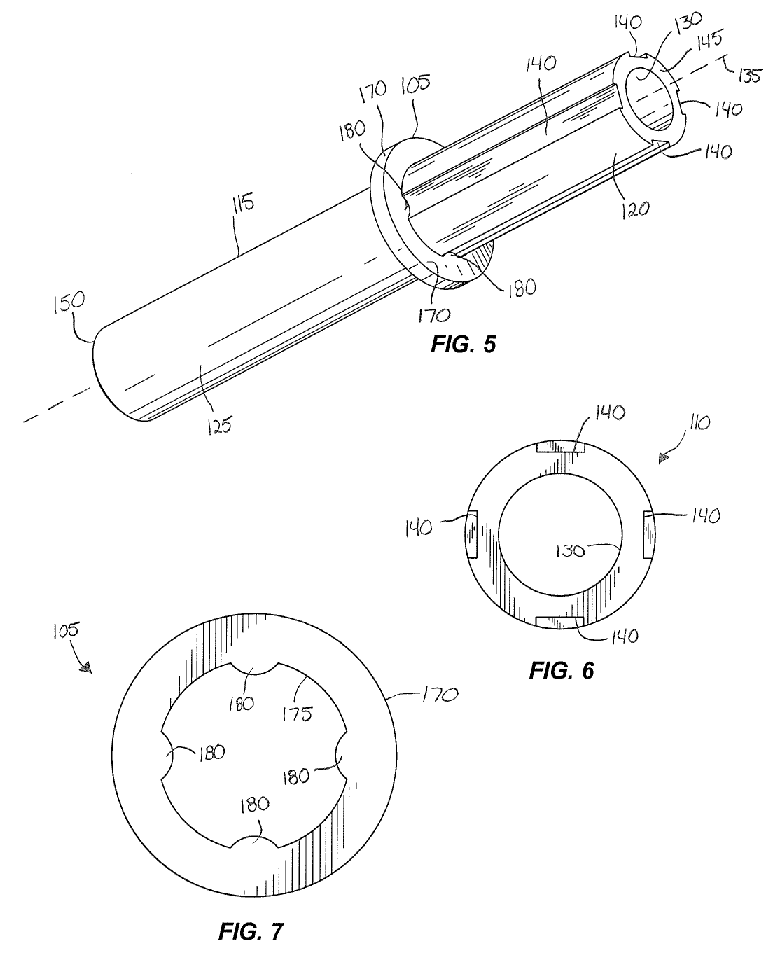

The first portion 120 is defined by a first or outer cross-section and extends through the horizontal extrusion 85. The first portion 120 has a plurality of grooves 140 that extend axially along the bar 115 from a first end 145 of the sacrificial member 110 toward a second end 150 of the sacrificial member 110. The first portion 120 may include one or more grooves 140, and the quantity of grooves 140 is at least partially determined by the desired energy absorption characteristics of the energy absorption device 100 and the material properties of the shear member 105 and/or the sacrificial member 110. FIGS. 5 and 6 show that the second portion 125 is an elongated portion of the bar 115 having a generally circular cross-section. The second portion 125 defines respective inward ends of the grooves 140 such that the grooves 140 do not axially extend the entire length of the sacrificial member 110.

As shown in FIG. 4, the cavity 130 receives one end of the “U”-shaped attachment arm 55. The “U”-shaped attachment arm 55 is attached to the sacrificial member 110 by fasteners 155 (e.g., nuts). In the illustrated construction, the fasteners 155 are separated from the sacrificial member 110 by two metallic washers 160 and a neoprene washer 165. The neoprene washer 165 absorbs at least some expected ordinary operating conditions of the vehicle 15. Generally, expected ordinary operating conditions of the vehicle 15 are defined as normal or commonplace conditions that include relatively small vibrations and other movements caused by normal over-the-road driving conditions (e.g., speed bumps, potholes, cracks in the road, etc.). In the illustrated construction, the sacrificial member 110 is rigidly mounted to the ceiling 50 of the vehicle 15 above the occupant support 20 via the “U”-shaped attachment arm 55, the fasteners 155, and the washers 160, 165.

As shown in FIGS. 4 and 5, the shear member 105 includes a ring 170 that is disposed about the first portion 120 of the bar 115 and that surrounds the second portion 125 of the bar 115. FIGS. 4, 5, and 7 show that the ring 170 defines an opening 175 and has protrusions 180 extending radially inward into the opening 175. Generally, the protrusions 180 abut the inward ends of the grooves 140. In an at-rest condition, the shear member 105 is bottomed out in the grooves 140. In other words, the protrusions 180 of the shear member 105 rest on the bottom or inward ends of the grooves 140 under the influence of gravity when the shear member 105 is in an at-rest condition.

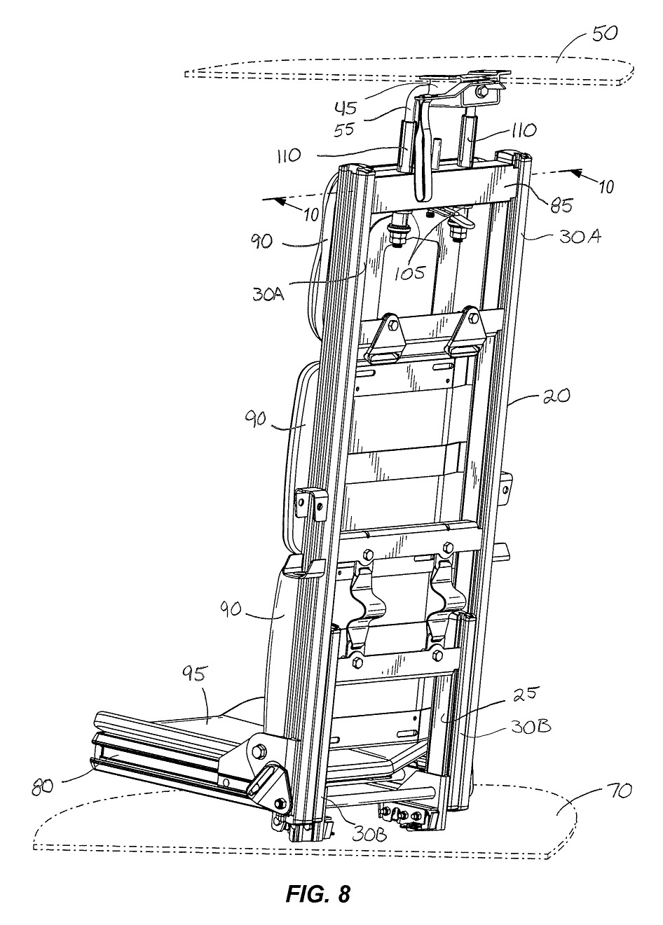

The protrusions 180 define a second or inner cross-section of the shear member 105 that is complementary to the first cross-section of the first portion 120 such that the protrusions 180 and the grooves 140 generally align the shear member 105 on the sacrificial member 110. The grooves 140 cooperate with the protrusions 180 to align the ring 170 for shearing the sacrificial member 110 along the axis 135. Although the shear member 105 illustrated in FIG. 7 includes four protrusions 180, the shear member 105 may include fewer or more than four protrusions 180. The shear member 105 may also include other cross-sections depending on the desired energy absorption response characteristics between the shear member 105 and the sacrificial member 110. A non-metallic washer 185 (e.g., plastic) is positioned between the horizontal extrusion 85 and the shear member 105 to inhibit corrosion (e.g., galvanic corrosion) between the horizontal extrusion 85 and the shear member 105.

FIG. 4 shows that the shear member 105 abuts the second portion 125 of the sacrificial member 110 (i.e., the shear member 105 is bottomed out in the grooves), and the shear member 105 is engaged with the horizontal extrusion 85 via the washer 185 such that the shear member 105 is rigidly mounted to the occupant support 20. In other words, the shear member 105 generally moves with the occupant support 20. In the illustrated construction, the shear member 105 is rigidly mounted to a rear side of the occupant support 20 opposite a front side against which the occupant rests. In other constructions, the shear member 105 may be rigidly mounted to the vehicle 15 and the sacrificial member 110 may be rigidly mounted to the occupant support 20.

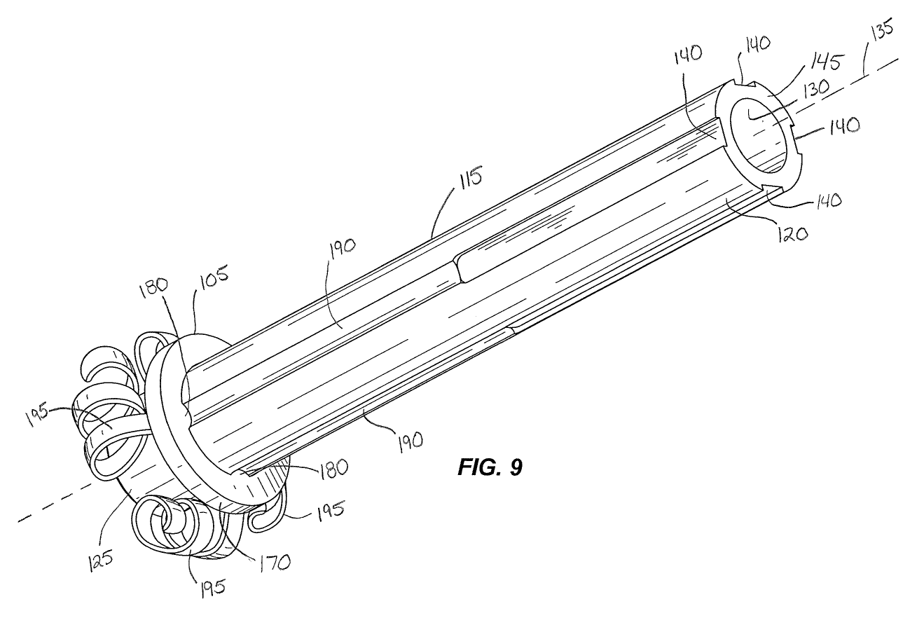

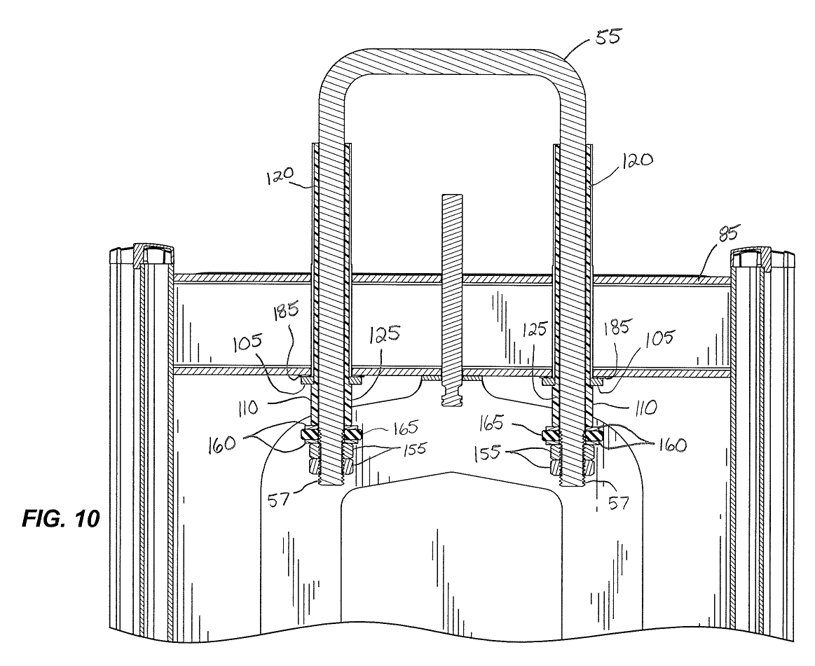

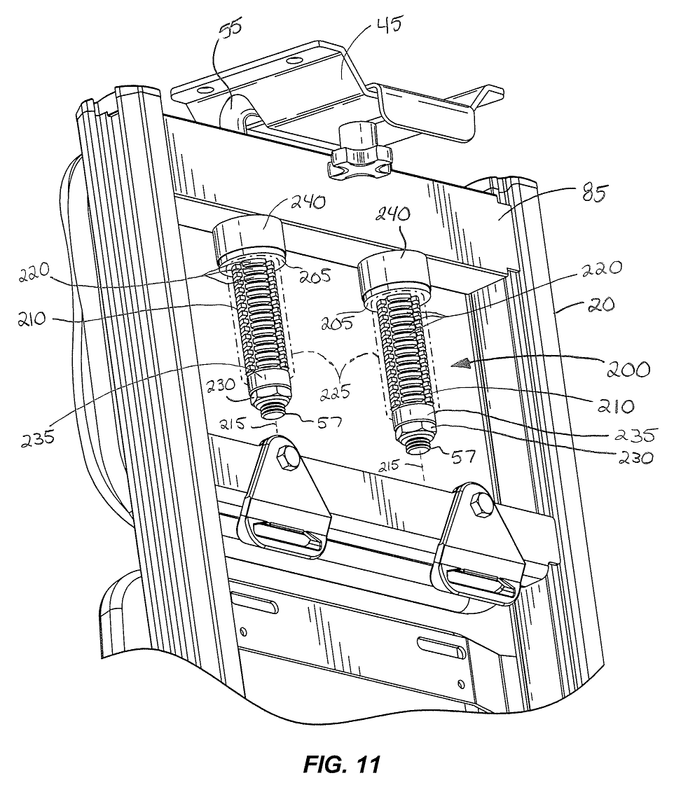

FIGS. 1-4 show the seat 10 and the energy absorption device 100 in a first state prior to rapid upward movement of the vehicle 10. FIGS. 8-10 show the seat 10 and the energy absorption device 100 in a second state after rapid upward movement of the vehicle 10. With regard to FIGS. 8-10, the occupant support 20 has moved downward relative to the mounting assembly 25. The occupant support 20 has further moved downward relative to the ceiling 50. Downward movement of the occupant support 20 forces the shear member 105 downward into engagement with the second portion 125. Due to the hardness differential between the shear member 105 and the sacrificial member 110, the shear member 105 shears a circumferential portion of the sacrificial member 10. In construction of the invention illustrated in FIGS. 8-10, the protrusions 180 shear the sacrificial member 110 along the axis 135, which leave corresponding grooves 190 in the elongated portion of the sacrificial member 110. In this regard, the shear member 105 effectively extends the grooves 140 as the shear member creates the grooves 190 in the elongated portion of the sacrificial member 110, and generates sheared portions 195 of the sacrificial member 110. The sheared portions 195 may be partially or completely sheared from the second portion 125 by the shear member 105.

FIG. 11 shows another energy absorption device 200 for the seat 10. The energy absorption device 200 includes a shear member 205 and a sacrificial member 210. The sacrificial member 210 is defined by a bar that has a cavity similar to the cavity 130 for receiving the “U”-shaped attachment arm 55, and an elongated portion extending along a sacrificial member axis 215. The sacrificial member 210 has a plurality of protrusions 220 spaced apart from each other along the length of the elongated portion. In some constructions, the protrusions 220 may include corner edges or needle-like projections that extend generally away from the elongated portion (i.e., non-parallel with the axis 215).

The protrusions 220 may be formed from any suitable material (e.g., metal, plastic, composite) having a first shear limit. Generally, the length of the sacrificial member 210 is determined based on the vertical space available in the vehicle 15 and the desired energy absorption properties of the energy absorption device 200. In some constructions, a cover 225 may at least partially enclose the sacrificial member 210 to limit airborne debris from the sacrificial member 210. The “U”-shaped attachment arm 55 is attached to the sacrificial member 210 via fasteners 230 and washers 235.

The shear member 205 is disposed about an upper portion of the sacrificial member 210, and has a substantially circular opening similar to the opening 175 surrounding the sacrificial member 210. The shear member 205 abuts the protrusions 220 and is engaged with the horizontal extrusion 85 via a washer 240 (e.g., a neoprene washer) such that the shear member 205 is rigidly mounted to the occupant support 20 and separated from the horizontal extrusion 85 to limit corrosion. The shear member 205 has a second shear limit and is generally harder than the sacrificial member 210 such that the shear member 205 is adapted to shear the protrusions 220 off the elongated portion with the opening in response to rapid upward movement of the vehicle 15.

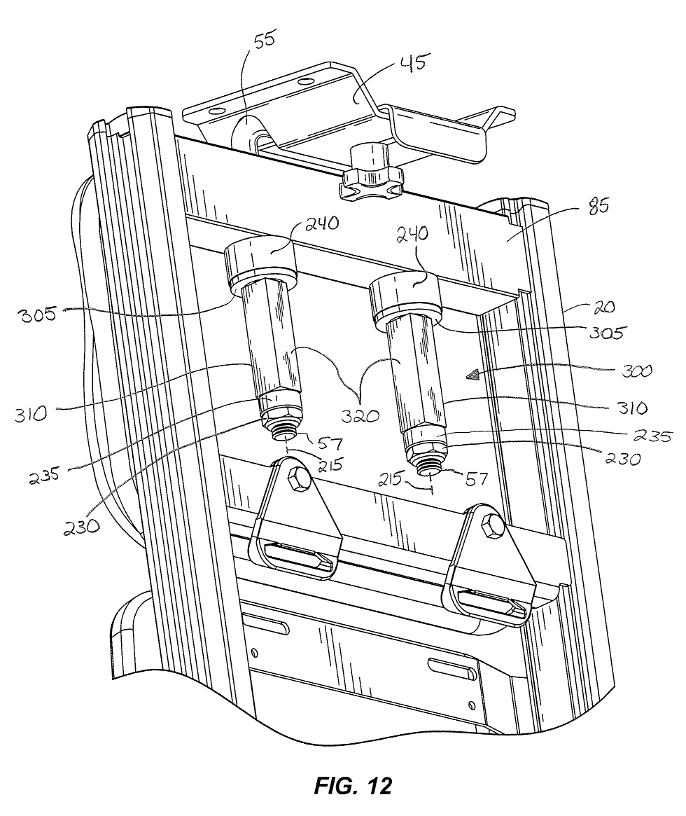

FIG. 12 shows another energy absorption device 300 for the seat 10. The energy absorption device 300 includes a shear member 305 and a sacrificial member 310. Except as described below, the shear member 305 is similar to the shear members 105, 205, and the sacrificial member 310 is similar to the sacrificial members 110, 210. The shear member 305 has an opening with a shear radius of curvature (e.g., an inner circular cross-section, etc.). The sacrificial member 310 includes a bar 320 having an elongated portion with a non-circular cross-section (e.g., triangular cross-section, rectangular cross-section, or another shape having corners). In the illustrated construction, the bar 320 has a substantially square cross-section. The shear member 305 has a first hardness and the sacrificial member 310 has a second hardness that is smaller than the first hardness. The shear member 305 is coupled to the bar 320, and the shear member 305 is adapted to shear the bar 320 with the opening 315 to impart the shear radius of curvature to the surface of the bar 320. The shear radius of curvature is applied to the sacrificial member 310 as the corners of the bar 320 are sheared off.

Although the present invention is described and illustrated with regard to the seat 10 and the energy absorption device 100 (see FIGS. 1-10), it should be understood that the energy absorption devices 200, 300 operate in a similar manner. In operation, the energy absorption device 100 limits undesirable physical effects (e.g., compression of the occupant's spine, other bodily injuries, etc.) on the occupant that may be caused by rapid upward movement of the vehicle 15 that is consistent with an explosion occurring under the vehicle 15. On the other hand, expected ordinary operating conditions of the vehicle 15 are associated with relatively small vibrations and other movements caused by normal over-the-road driving conditions.

Generally, the shear member 105 is engaged with the sacrificial member 110 to inhibit vertical movement of the occupant support 20 relative to the mounting assembly 25 under expected ordinary operating conditions of the vehicle 15. Normal or expected ordinary operating conditions of the vehicle 15 are insufficient to cause substantial movement of the occupant support 20 relative to the mounting assembly 25. Under these conditions, the shear member 105 and the sacrificial member 110 are generally immovable relative to each other.

When rapid upward movement of the vehicle 15 occurs (e.g., when an explosion occurs under the vehicle 15), the force transferred to the vehicle 15 by the rapid upward movement accelerates the mounting assembly 25 upward very rapidly. The rigidly mounted sacrificial member 110 also moves rapidly upward with movement of vehicle 15 because the sacrificial member 110 is rigidly mounted to the ceiling 50. Inertia of the occupant in the occupant support 20 causes the occupant to exert a very high downward force on the support surface 95 of the occupant support 20 due to upward acceleration of the mounting assembly 25 such that the occupant support 20 moves relative to the mounting assembly 25, or more accurately, the mounting assembly 25 (and the rest of the vehicle 15) move upwardly as the occupant support 20 and inertia of the occupant resist upward movement. The high downward force on the occupant support 20 is transmitted or transferred to the energy absorption device 100 via the horizontal extrusion 85, which forces the shear member 105 generally downward. As a result of the upward movement of the sacrificial member 110 with the vehicle 15 and the downward force on the occupant support 20 arising from inertia of the occupant in the presence of a rapid upward movement of the vehicle 15, the shear member 105 shears a circumferential portion of the sacrificial member 110. The hardness of the sacrificial member 110 partially resists shearing by the shear member 105, which in turn slows movement (i.e., does not stop movement) of the occupant support 20 in the downward direction relative to the rapid upward movement of the mounting assembly 25. Shearing the sacrificial member 110 in this manner absorbs energy associated with the rapid upward movement of the vehicle 15 and accommodates downward movement of the occupant support 20 relative to the mounting assembly 25, thereby reducing upward acceleration of the occupant.

The occupant support 20, and therefore the occupant, is able to move downward relative to the mounting assembly 25 in response to rapid upward acceleration of the vehicle 15 due to the cooperative properties of the shear member 105 and the sacrificial member 110. Generally, characteristics of the shear member 105 and the sacrificial member 110 may be selected and/or designed to obtain the desired energy absorption characteristics to thereby limit or inhibit injurious forces on the occupant that may otherwise be caused by rapid upward acceleration of the vehicle 15.

Various features and advantages of the invention are set forth in the following claims.

What is claimed is:

1. A seat for a vehicle, the seat comprising:
an occupant support defining a support surface for an occupant of the seat;
a mounting assembly coupled to the occupant support and adapted to rigidly mount to the vehicle, the mounting assembly further adapted to resist non-vertical movement of the occupant support relative to the mounting assembly, and to guide vertical movement of the occupant support relative to the mounting assembly;
a shear member having a first hardness; and
a sacrificial member having a second hardness lower than the first hardness, one of the shear member and the sacrificial member adapted to be rigidly mounted to the vehicle and the other of the shear member and the sacrificial member rigidly mounted to the occupant support, the shear member engaged with the sacrificial member to inhibit vertical movement of the occupant support relative to the mounting assembly under expected ordinary operating conditions of the vehicle,
wherein a circumferential portion of the sacrificial member is sheared by the shear member in response to a generally downward force on the occupant support arising from inertia of the occupant in the presence of a rapid upward movement of the vehicle, the shearing of the sacrificial member by the shear member absorbing energy associated with the rapid upward movement of the vehicle and accommodating downward movement of the occupant support relative to the mounting assembly, the absorption of energy by shearing the sacrificial member reducing acceleration of the occupant.

2. The seat of claim 1, wherein the sacrificial member includes an elongated portion, wherein the shear member includes a ring surrounding the elongated portion, and wherein shearing of the sacrificial member includes shearing a surface of the elongated portion with the ring.

3. The seat of claim 1, wherein the occupant support and the mounting assembly include inter-engaging portions to facilitate generally vertical movement of the occupant support relative to the mounting assembly.

4. The seat of claim 1, wherein the sacrificial member includes a bar having a first portion with a groove extending axially along the bar from a first end of the sacrificial member toward a second end of the sacrificial member, and a second portion abutting the first portion and defining an inward end of the groove, wherein the shear member includes a protrusion engaged with the bar within the groove and abutting the inward end of the groove, and wherein shearing the sacrificial member includes shearing the second portion of the bar with the protrusion.

5. The seat of claim 1, wherein the mounting assembly includes at least one extruded track interconnecting the mounting assembly and the occupant support together in vertical sliding relationship.

6. The seat of claim 1, wherein the mounting assembly includes a portion that is in vertically sliding relationship with a portion of the occupant support.

7. The seat of claim 1, wherein the sacrificial member is adapted to be rigidly mounted to the vehicle and the shear member is rigidly mounted to the occupant support.

8. The seat of claim 1, wherein the sacrificial member is adapted to be rigidly mounted to a wall of the vehicle, and wherein the shear member is rigidly mounted to a rear side of the occupant support opposite a front side against which an occupant rests.

9. The seat of claim 8, wherein the sacrificial member is adapted to be rigidly mounted to a ceiling of the vehicle above the occupant support, and wherein the shear member is rigidly mounted to the occupant support.

10. The seat of claim 1, wherein the shear member and sacrificial member engage each other adjacent a top of the occupant support.

11. The seat of claim 1, wherein the sacrificial member is formed from at least one of a plastic material and a composite material.

12. The seat of claim 1, wherein the shear member is formed from a metal material.

13. The seat of claim 1, wherein a portion of the sacrificial member is defined by a first cross-section, and wherein the shear member includes an opening defined by a second cross-section that is complementary to the first cross-section.

14. The seat of claim 1, wherein a surface of the sacrificial member is sheared by the shear member under the influence of a downward force on the occupant support arising from inertia of the occupant in the presence of a rapid upward movement of the vehicle consistent with an explosion occurring under the vehicle.

15. The seat of claim 1, wherein the sacrificial member includes a bar having a non-circular cross-section, wherein the shear member includes a circular opening having a shear radius of curvature and surrounding the elongated portion, and wherein shearing the sacrificial member includes shearing the bar with the circular opening to impart the shear radius of curvature to a surface of the bar.

16. The seat of claim 1, wherein the sacrificial member includes a bar having a plurality of corner edges, wherein the shear member includes an opening surrounding at least a portion of the bar and abutting the plurality of corner edges, and wherein shearing the sacrificial member includes shearing the corner edges off the bar with the opening.

17. The seat of claim 1, wherein the sacrificial member includes an elongated portion extending along a sacrificial member axis and protrusions extending generally away from the elongated portion, and wherein shearing the sacrificial member with the shear member includes shearing the protrusions off the elongated portion.
